(19) United States
(12) Patent Application Publication
(10) Pub. No.: US 2025/0249625 A1
(43) Pub. Date: Aug. 7, 2025

(54) CONSUMER PRODUCT PACKAGING SYSTEM

(71) Applicant: BETTA Packaging LLC, West Hartford, CT (US)

(72) Inventor: Jim Francis Warner, West Hartford, CT (US)

(73) Assignee: BETTA Packaging LLC, West Hartford, CT (US)

(21) Appl. No.: 19/047,199

(22) Filed: Feb. 6, 2025

Related U.S. Application Data
(60) Provisional application No. 63/550,053, filed on Feb. 6, 2024.

(51) Int. Cl. B29C 43/36; B29C 43/04; B29C 43/18; B29K 1/00; B29L 31/00; B65D 23/02

(52) U.S. Cl. CPC B29C 43/36; B29C 43/04; B29C 43/18; B65D 23/02; B29C 2043/3665; B29K 2001/00; B29L 2031/7158

(57) ABSTRACT

Methods of forming a molded product package include providing a molding system, the molding system having a first pressing member, a second pressing member, and a core member. The methods further include introducing mold material into the molding system, pressing the mold material between the first pressing member and the second pressing member, and withdrawing the core member from the mold material and moving the first pressing member and second pressing member away from each other to form a molded package section from the mold material. The molded package section includes a body portion and a neck portion, connected to the body portion and defining an opening fluidly connected to an interior volume defined by the body portion. The body portion and the neck portion are made of, at least partially, pulp fiber. The neck portion may be configured to be closed and/or sealed by a closure element.

### RELATED APPLICATIONS

This application claims the benefit of U.S. Provisional Application No. 63/550,053, filed Feb. 6, 2024, herein incorporated by reference in its entirety for all purposes.

### TECHNICAL FIELD

The present disclosure relates to molded products, such as molded product packages, and molding systems for making molded products. More particularly, the present disclosure relates to molding products containing, at least in part, pulp fiber.

### BACKGROUND

Molded products such as product packaging are often formed using non-environmentally friendly materials, such as polymer/thermoplastic materials, e.g. polyethylene terephthalate (PET). Although consumers and manufacturers desire to use sustainable and environmentally friendly materials, the use of polymer/thermoplastic materials in product packages continues for a variety of reasons. Plant-based materials, such as pulp fiber, have been used for certain product package applications. For example, product packages containing pulp fiber have been utilized in food service trays, beverage carriers, end caps, trays, plates, bowls, and clamshell containers. However, limitations in manufacturing methods make many plant-based materials unsuitable or undesirable for many product package applications. Conventional molded packaging methods often involve complex shaping and finishing processes, which can be inefficient and difficult to scale. Additionally, many molded fiber products require improved barrier properties, sealing mechanisms, and labeling solutions to meet commercial requirements.

U.S. Pat. No. 11,247,804 is hereby incorporated by reference in its entirety and describes product packages in the form of multi-barrier bottles having an exterior barrier made of ecologically friendly material, such as sugarcane (bagasse), bamboo, wheat straw, banana leaves, hay, grasses, cornstalks, recycled pulp, fiber materials, and/or the like. U.S. Reissued Pat. No. RE48,027 is hereby incorporated by reference in its entirety and describes product packages in the form of containers for liquids, the containers being made from environmentally friendly material.

There remains a need for a molded packaging solution that is efficiently manufactured, provides structural integrity, incorporates barrier functionality, and enables various closure, sealing, and labeling techniques.

### SUMMARY

The present disclosure provides a method for forming a molded product package and a molded product package produced thereby. In embodiments, the molding method includes: providing a molding system with a first pressing member, a second pressing member, and a core member; introducing a mold material, such as pulp fiber, into a space formed between the first and second pressing members; inserting the core member to press the mold material, shaping it into a molded package section; and withdrawing the core member and separating the pressing members to release the formed molded package section.

In embodiments the molded product package produced includes: a body portion, a neck portion, and a base portion, where at least one portion comprises pulp fiber; a closure element configured to seal a neck opening of the package; a film lining applied to the interior surface of the neck portion, body portion, and base portion to enhance barrier properties; and labeling applied to the neck portion, body portion, base portion, and/or closure element.

### BRIEF DESCRIPTION OF THE DRAWINGS

FIG. 1A is longitudinal section diagram of a molding system according to the present disclosure;

FIG. 1B is longitudinal section diagram of the molding system of FIG. 1A pressing mold material into a molded package section according to the present disclosure;

FIG. 1C is longitudinal section diagram of the molding system of FIG. 1A with the molded package section with angled sides released from the molding system according to the present disclosure;

FIG. 1D is longitudinal section diagram of another embodiment of a molding system, with a molded package section with straight sides released from the molding system according to the present disclosure;

FIG. 1E is a longitudinal section diagram of another embodiment of mold pressing members providing an insert for insertion molding in a molding system according to the present disclosure;

FIG. 2A is a front view of a molded product according to the present disclosure;

FIG. 2B is a front view of the molded product of FIG. 2A with half of the molded product shown in longitudinal-section and with a closure element removed according to the present disclosure;

FIG. 2C is a top view of the molded product of FIG. 2A according to the present disclosure;

FIG. 3A is a half section view of a neck portion of a molded product according to the present disclosure;

FIG. 3B is a is a half section view of a neck portion of a molded product according to the present disclosure;

FIG. 3C is a is a half section view of a neck portion of a molded product according to the present disclosure;

FIG. 4 is a half section view of a neck portion, having molded threads, according to the present disclosure;

FIG. 5A is a half section view of a neck portion of a molded product, including a threaded ring insert that is insertion molded into the neck portion, according to the present disclosure;

FIG. 5B is a perspective diagram of the threaded ring insert of FIG. 5A according to the present disclosure.

FIG. 5C is a perspective diagram of a lug ring insert according to the present disclosure.

FIG. 5D is a perspective diagram of a snap portion ring insert, showing also the detail of a snap closure portion of a closure element, according to the present disclosure.

FIG. 6A is a longitudinal section of a threaded collar on a neck portion of a molded product, with a closure element applied thereto, according to the present disclosure.

FIG. 6B is a half section view of the threaded collar of FIG. 6A according to the present disclosure.

FIG. 6C is a half section view of a lug collar according to the present disclosure.

FIG. 6D is a half section view of a snap portion collar according to the present disclosure.

FIG. 7A is a longitudinal section drawing of a closure insert according to the present disclosure, showing also a sealing element.

FIG. 7B is a half section view of a threaded closure insert according to the present disclosure.

FIG. 7C is a half section view of a lug closure insert according to the present disclosure.

FIG. 8 is a front view of a molded product according to the present disclosure, showing surfaces bearing labeling according to the present disclosure;

FIG. 9A a longitudinal section diagram depicting spraying of a liquid barrier-forming material according to the present disclosure;

FIG. 9B is a longitudinal section diagram of an uninflated film on an inflator nozzle according to the present disclosure;

FIG. 9C is a longitudinal section diagram depicting the film of FIG. 9B after inflation and after the removal of the inflator nozzle according to the present disclosure; and

FIG. 10 is an exploded schematic diagram of a porous surface of a core member according to the present disclosure.

FIG. 11A through FIG. 11N are half section views showing shapes into which a molded product package of the present disclosure may be formed.

### DETAILED DESCRIPTION

One embodiment provides a method of forming a molded product package comprising: providing a molding system, the molding system comprising: a first pressing member; a second pressing member; and a core member; introducing mold material into a space formed between the first pressing member and the second pressing member; inserting the core member into a cavity defined by the first pressing member and the second pressing member so as to press the mold material between the core member, the first pressing member, and the second pressing member; and withdrawing the core member from the mold material and moving the first pressing member and second pressing member away from each other to form a molded package section from the mold material.

Another embodiment provides such a method, wherein the core member is configured with a draft that is angled to facilitate withdrawal of the core member.

A further embodiment provides such a method, wherein the core member is configured comprising a core body portion and a core neck portion, the core neck portion having a width that is narrower than that of the core body portion.

Yet another embodiment provides such a method, wherein the mold material comprises pulp fiber.

A yet further embodiment provides such a method, wherein at least a mold material-facing surface of one or more of the first pressing member, the second pressing member, and the core member is fluid-permeable such that water permeates therethrough during the pressing of the mold material.

Still another embodiment provides such a method, wherein the fluid permeability is provided by a porous material, a screen, a perforated surface, a slotted surface, a fibrous structure, a permeable membrane, a lattice, or microchannels.

A still further embodiment provides such a method, wherein during the pressing of the mold material, water from the mold material is permeated through the first pressing member, the second pressing member and/or the core member.

Even another embodiment provides such a method, further comprising applying a film to an interior surface of the molded package section.

A still even another embodiment provides such a method, wherein the applying the film comprises spraying a film-forming material into the interior volume of the molded package section.

An even further embodiment provides such a method, wherein the applying the film comprises inserting a preform or an expandable membrane structure defining a sealed enclosure with a single inflation port into an interior volume of the molded product section through an opening defined at a neck portion of the molded package section or through an opening defined at a bottom of the molded package section; and inflating the preform or expandable membrane structure.

A still even another embodiment provides such a method, wherein the inflating the expandable membrane structure comprises filling the expandable membrane structure with a product.

A still even further embodiment provides such a method, wherein the exterior surface of the molded package section is substantially parallel to the withdrawal direction of the core member, such that the exterior surface has no draft angle.

Still yet another embodiment provides such a method, further comprising attaching a base portion to the molded package section at an end of the molded package section in the direction in which the core member was withdrawn.

A still yet further embodiment provides such a method, wherein the attaching the base portion is through press-fitting.

Even yet another embodiment provides such a method, wherein the attaching the base portion is through use of an adhesive.

An even yet further embodiment provides such a method, wherein the attaching the base portion is through bonding.

Still even yet another embodiment provides such a method, wherein the first pressing member and the second pressing member fit together to form a substantially closed mold, leaving only an opening for insertion of the core member, wherein a parting line between the first pressing member and the second pressing member extends parallel to the direction in which the core member is inserted and withdrawn.

A still even yet further embodiment provides such a method, wherein an insert, structured from a rigid material and configured to mate with a closure portion, is provided to a neck portion of the molded package section by the first pressing member, the second pressing member, or the core member.

Yet still even another embodiment provides such a method, wherein a collar, structured from a rigid material and configured to mate with a closure portion, is provided on a neck portion of the molded package section.

A yet still even further embodiment provides a method for manufacturing a packaged product, comprising: a method as described above; and filling the molded package section with a product from the end of the molded package section in the direction in which the core member was withdrawn, where said filling with the product is performed prior to the attaching the base portion.

A yet still even further still embodiment provides a molded product package comprising: a body portion; a base portion connected to an end of the body portion opposite from an end of the body portion to which the neck portion is connected; and a neck portion integrally connected to the body portion and defining an opening fluidly connected to an interior volume defined by the body portion and the base portion; wherein at least one of the body portion, the neck portion, and the base portion comprises pulp fiber.

Another further embodiment provides such a molded product package, further comprising a closure element configured to seal the opening of the neck portion from an exterior of the molded product package.

Another yet further embodiment provides such a molded product package, wherein the closure element comprises an elastomeric sealing member configured to seal the opening of the neck portion.

Still another further embodiment provides such a molded product package, wherein the closure element comprises pulp fiber.

Another still further embodiment provides such a molded product package, wherein the closure element comprises an inner cap and an overcap, wherein the overcap is made primarily of pulp fiber.

Even another further embodiment provides such a molded product package, wherein a top surface of the closure element comprises a finger pad contoured to receive a fingertip of a user

Another even further embodiment provides such a molded product package, wherein the closure element comprises a closure element insert.

Another still even further embodiment provides such a molded product package, wherein the closure element insert is made at least partially of polymer.

Another still even further embodiment still provides such a molded product package, wherein the closure element insert defines an interior facing screw thread configured to engage with an exterior facing screw thread arranged at the neck portion.

Still yet another even further embodiment still provides such a molded product package, wherein the closure element insert defines an interior facing lug portion configured to engage with an exterior facing lug portion arranged at the neck portion.

Another still yet further embodiment provides such a molded product package, wherein the closure element insert defines an interior facing snap closure portion configured to engage with an exterior facing snap closure portion arranged at the neck portion.

Even another yet another further still embodiment provides such a molded product package, further comprising a threaded ring insert, disposed on the neck portion, configured providing the exterior facing screw thread configured to engage with the interior facing screw thread of the closure element.

An even yet further embodiment provides such a molded product package, further comprising a lug ring insert, disposed on the neck portion, configured providing the exterior facing lug portion configured to engage with the interior facing lug portion of the closure element.

Still even yet another embodiment provides such a molded product package, further comprising a snap portion ring insert, disposed on the neck portion, configured providing the exterior facing snap closure portion configured to engage with the interior facing snap closure portion.

A still even yet further embodiment provides such a molded product package, further comprising a threaded collar, disposed on the neck portion, configured the exterior facing screw thread configured to engage with the interior facing screw thread of the closure element.

Yet still even another embodiment provides such a molded product package, further comprising a lug collar, disposed on the neck portion, configured providing the exterior facing lug portion configured to engage with the interior facing lug portion of the closure element.

A yet still even further embodiment provides such a molded product package, further comprising a snap portion collar, disposed on the neck portion, configured providing the exterior facing snap closure portion configured to engage with the interior facing snap closure portion.

A yet still even further still embodiment provides such a molded product package, further comprising a film lining an interior surface of the body portion and/or the base portion that defines the interior volume.

A still even another embodiment provides such a molded product package, wherein the film is configured to prevent contact of any content contained in an interior volume from coming into contact with any of the pulp fiber of the body portion.

A still even further embodiment provides such a molded product package, wherein the film lines the interior surface removably.

Still yet another embodiment provides such a molded product package, wherein the film comprises a biodegradable material.

A still yet further embodiment provides such a molded product package, wherein the biodegradable material comprises cellulose nanofibers.

Even yet another embodiment provides such a molded product package, wherein the film is a recyclable material.

An even yet further embodiment provides such a molded product package, wherein the film comprises a multilayer film.

Still even yet another embodiment provides such a molded product package, wherein the film comprises a mono-material barrier film.

A still even yet further embodiment provides such a molded product package, wherein the film lines an external surface of a lip portion of the neck portion.

Yet still even another embodiment provides such a molded product package, wherein the overcap further comprises a printed portion.

A yet still even further embodiment provides such a molded product package, wherein the body portion is asymmetrical with respect to an axial direction of the neck portion.

A yet still even further still embodiment provides such a molded product package, wherein at least one outer surface of at least one of the body portion, base portion, neck portion, and overcap bears labeling.

Another further embodiment provides such a molded product package, wherein the wherein the labeling comprises at least one selection from product branding information, a logo, nutritional information, a UPC, a QR code, content information, volume or weight labeling, regulatory compliance information, recycling instructions, expiration date markings, lot or batch numbers, barcodes, handling or storage instructions, allergen warnings, multilingual translations, promotional or marketing messages, authentication or anti-counterfeiting markers, hazard warnings, and tamper-evident indicators.

Another yet further embodiment provides such a molded product package, wherein the labeling is applied to the at least one outer surface of at least one of the body portion, base portion, neck portion, and overcap by at least one of embossing, debossing, direct printing, pad printing, screen printing, digital printing, laser etching, thermal transfer printing, hot stamping, cold stamping, in-mold labeling (IML), pressure-sensitive adhesive labels, shrink sleeves, stretch labels, wrap-around labels, glue-applied labels, inkjet printing, flexographic printing, gravure printing, RFID or NFC tags, tamper-evident seals, or any combination thereof.

Still another further embodiment provides such a molded product package, wherein the exterior surface of the body portion is configured in a shape selected from one or more of convex, concave, flat, undulating, faceted, stepped, ribbed, contoured, multi-tiered, textured, asymmetrical, spiraled, polygonal, or freeform organic shapes, wherein the exterior surface of the body portion is configured to be releasable from a first pressing member and a second pressing member upon separation of the first pressing member and the second pressing member.

Reference will now be made in detail to various embodiments. Each example is provided by way of explanation and is not meant as a limitation and does not constitute a definition of all possible embodiments.

The present disclosure provides methods of making a molded product, such as a molded product package, with a molding system. In embodiments, the product package is configured to be closed with a closure element to seal an interior cavity of the product package.

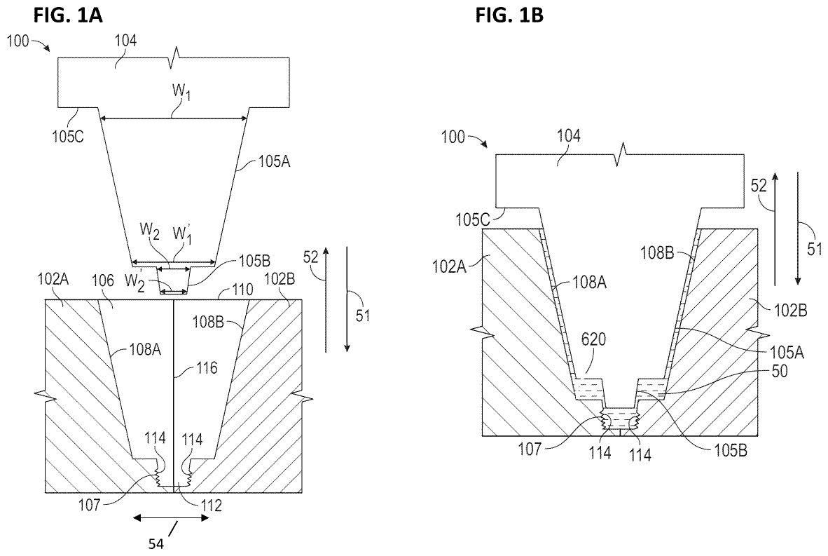

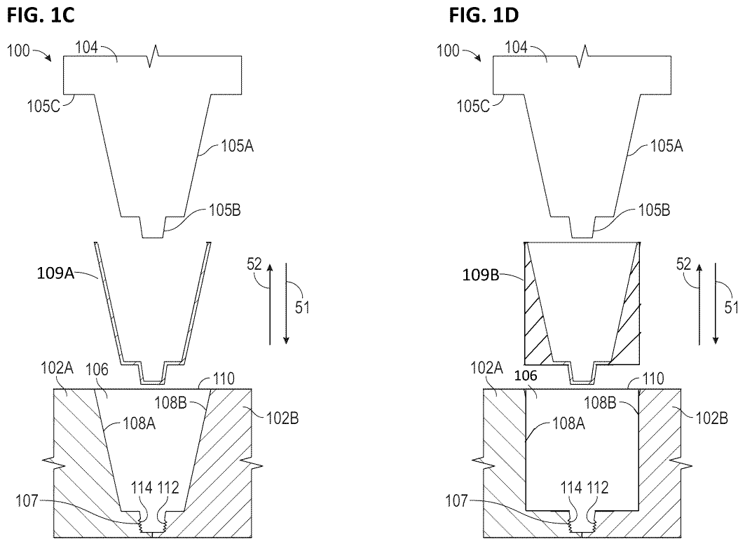

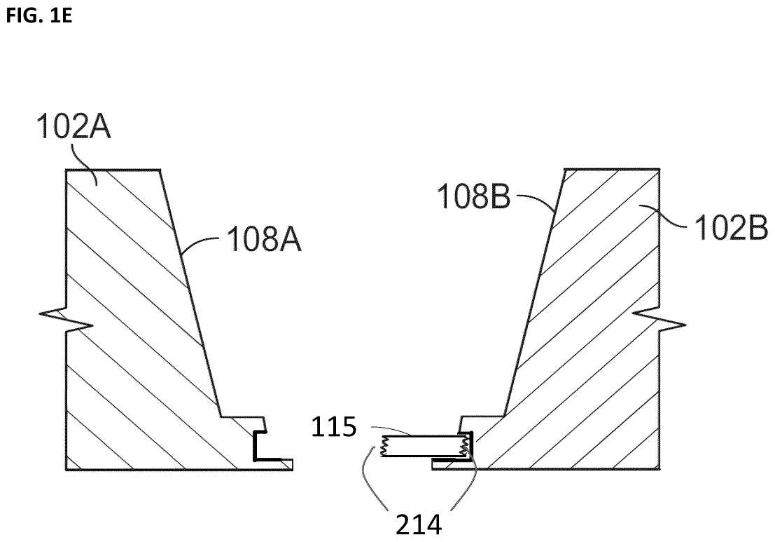

Referring to FIG. 1A, a molding system 100 is shown in accordance with embodiments of the present disclosure. In embodiments, the molding system 100 includes a first pressing member 102A, a second pressing member 102B, opposing each other, along with a core member 104. The pressing members 102A and 102B are shown in longitudinal-section view. When the pressing members 102A and 102B are pressed together, they form a cavity 106 defined by walls 108A, 108B of each respective pressing member 102A and 102B. That is, the first pressing member 102A and the second pressing member 102B fit together to form a substantially closed mold, leaving only an opening, an open end 110, for insertion of the core member 104.

As depicted in FIG. 1A, in embodiments the cavity 106 has an open end 110 and a closed end 112. The cavity 106 may optionally have a neck cavity portion 107 at the closed end 112. While the closed end 112 is shown as being closed, in embodiments the closed end 112 may have one or more openings for allowing egress of water or other mold material.

The core member 104 is configured with a size and shape that fits within the cavity 106 of the pressing members 102A and 102B such that the core member 104 can be inserted into the cavity 106 in a direction 51 from the open end 110 toward the closed end 112. The core member 104 can also be withdrawn from the cavity 106 when pulled in a direction 52 from the closed end 112 to the open end 110. The core member 104 includes a wall portion 105A forming a body portion of the core member 104 and a wall portion 105B forming a neck portion of the core member 104. The neck portion of the core member 104 has a size and shape to fit, at least partially, within the neck cavity portion 107 of the cavity 106 when the core member 104 is inserted in the cavity 106.

In embodiments, the wall portion 105A of the body portion and/or the wall portion 105B of the neck portion of the core member 104 are tapered in the direction 51 to provide a draft that is angled to facilitate withdrawal of the core member 104. In other words, the width W1 of the core member 104 at or near the top of body wall portion 105A of the core member 104 (as oriented in FIG. 1) narrows to a smaller width W1′ at or near the bottom of the core member 104 (as oriented in FIG. 1), and/or the width W2 at or near the top of wall portion 105B of the core member 104 (as oriented in FIG. 1) narrows to a smaller width W2′ at or near the bottom of wall portion 105B (as oriented in FIG. 1).

In embodiments, the walls of pressing members 102A and 102B that form the neck cavity portion 107 define a thread shape 114 for forming a screw thread feature on a neck of a product package, which is discussed in greater detail below. The pressing members 102A and 102B may be distinct, separate pieces or may be a single piece that are moveable with respect to each (e.g. through a hinge connection). In an embodiment depicted in FIG. 1A, the pressing members 102A and 102B are shown as two mold halves that meet along a parting line 116 such that the mold halves may be separated from one another, in directions 54, after molding of the product package so as to permit easy removal of the product package from the molding system 100. In the illustrated embodiment the parting line 116 is parallel to the directions 51 and 52 in which the core member 104 is inserted into and withdrawn from the cavity 106. However, there is no limitation thereto, where in other embodiments the first pressing member 102A and the second pressing member 102B may be configured such that this parting line is oriented in a non-parallel direction, such as a diagonal direction, when the pressing members 102A and 102B are brought together.

In embodiments, the core member 104 further includes a stop wall portion 105C that prevents the core member 104 from being inserted into the cavity 106 beyond a certain point. In such embodiments, the stop wall portion 105C will abut against a part of one or more of the pressing members 102A and 102B, thereby preventing further advancement of the core member 104 when being inserted in the direction 51 at the open end 110.

In embodiments, the body wall portion 105A and the neck wall portion 105B of the core member 104 are dimensioned such that, when the core member 104 is fully inserted, mold material 50, introduced into the cavity 106, is pressed between the pressing members 102A and 102B. In operation, mold material 50 is introduced between the pressing members 102A and 102B, either before, during and/or after insertion of the core member 104 into the cavity 106. In embodiments the molding system 100 is heated during pressing of the pressing members 102A and 102B. After a predetermined or desired amount of time has elapsed, the core member 104 is withdrawn from the cavity and the pressing members 102A and 102B are moved away from each other, thereby forming a product package from the mold material 50.

Withdrawing of the core member 104 in the direction 52 and separating the pressing members 102A and 102B away from each other allows the pressed mold material 50 to release from the pressing members 102A and 102B without damaging the intended shape of the product package. Tapering one or more wall portions 105A and 105B of the core member 104, as discussed above, reduces the risk that the mold material 50 will be pulled or dragged with the core member 104 during withdrawal of the core member 104 in the direction 52, or at least reduces the risk in comparison to a core member having wall portion(s) 105A and 105B that are non-tapered, straight walls in the direction 52.

A tapered core member 104 may result in the molded product having an internal draft angle. That is, instead of the interior walls of the molded product being parallel to each other (e.g. with respect to a longitudinal direction of the molded product in the direction 51 or direction 52), the interior walls form an angle with respect to each other, i.e. the interior walls are not parallel.

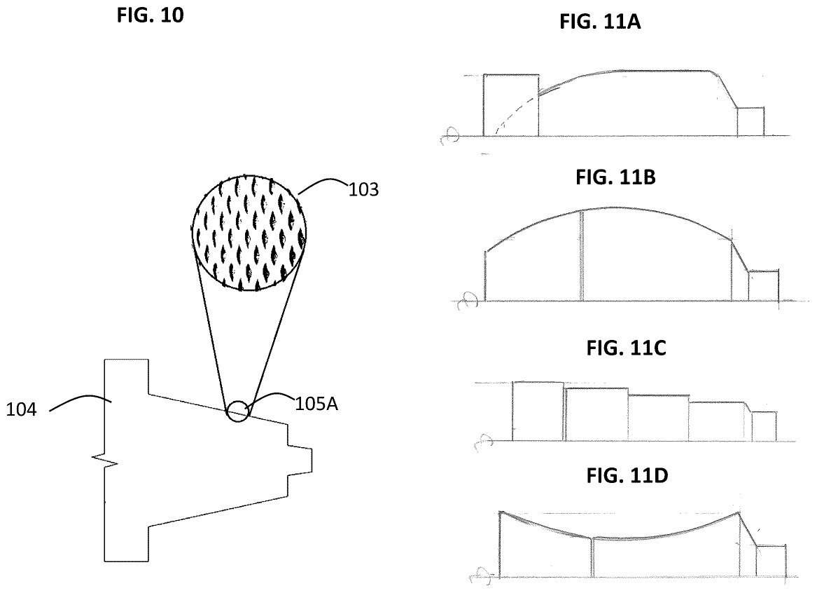

In embodiments, at least walls 108A and 108B of the first and second pressing members 102A and 102B, and/or a body wall portion 105A of the core member 104, as depicted in FIG. 1A, are configured to be fluid-permeable such that water permeates therethrough during the pressing of the mold material, so that water from mold material 50 being formed into a product package is permitted to escape. For example, in embodiments this fluid permeability is provided through portions of the walls 108A and 108B and/or the body wall portion 105A being formed from a porous metal, or comprising a screen, a perforated surface, a slotted surface, and fibrous structure, a permeable membrane, a lattice, microchannels, or the like. For example, the pressing member 102A and 102B and/or core member 104 material may be porous enough to allow water to permeate therethrough, but not porous enough to allow the pressed mold material 50 to permeate therethrough, thus providing a way to remove water or other fluid during the manufacturing process. For example, the body wall portion 105A of the core member 104 may have a porous surface 103 as illustrated in FIG. 10, allowing water, forced out of the mold material 50 during the process, to permeate into the core member 104, to be removed when the core member 104 is withdrawn. In embodiments, flow/suction of mold material and/or extracted liquid (e.g. water) may be augmented by heat that vaporizes a portion of the liquid in pulp fiber (or fibrous pulp) in the mold material 50. In embodiments the body wall portion 105A is fluid-permeable and the walls 108A and 108B are not, allowing the walls 108A and 108B to form a smooth surface for the molded package section 109A or 109B while allowing extracted liquid to exit through the body wall portion 105A of the core member 104.

Referring to FIG. 1B, the core member 104 is shown almost fully inserted into the cavity 106 (prior to the stop wall portion 105C contacting the pressing member 102A and 102B). The pressing of the pressing members 102A and 102B together and the insertion of the core member 104 causes molding of the mold material 50. After a predetermined amount of time or upon some other predetermined condition, the core member 104 is withdrawn in the direction 52 as shown in FIG. 1C, thereby forming a molded package section 109A from the mold material. The molded package section 109A is shown with a closed neck portion in FIG. 1C. The closed neck portion can be punctured later during manufacturing to have an opening defined by the neck portion or the neck portion can be molded to define a neck opening.

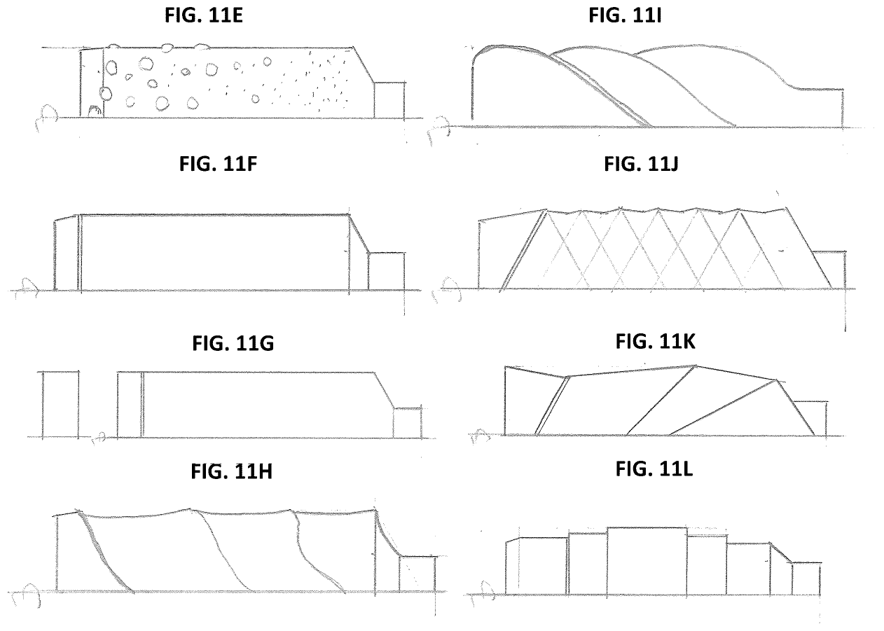

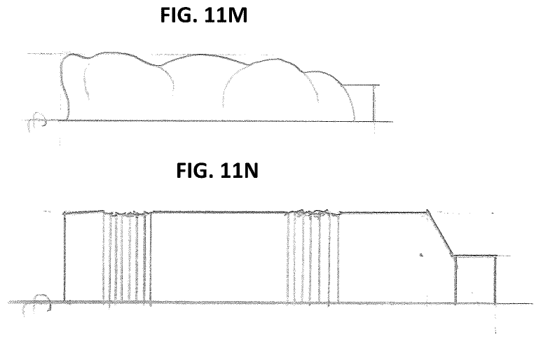

While in FIG. 1A through FIG. 1C, the walls 108A and 108B of the first and second pressing members 102A and 102B are depicted as being parallel to the body wall portion 105A of the core member 104, there is no limitation thereto; rather, as depicted in FIG. 1D, in embodiments the walls 108A and 108B of the first and second pressing members 102A and 102B may be of other configurations, such as, for example, parallel to the insertion/withdrawal directions 51 and 52, to thereby produce a molded package section 109B having walls that are substantially parallel to each other with no draft angle. In such embodiments the draft angle of the body wall portion 105A enables the core member 104 to be withdrawn easily, while molded package section 109B is easily removed from the first and second pressing members 102A and 102B through separation of the first and second pressing members 102A and 102B. Such embodiments enable a greater scope of design flexibility in the geometries that can be produced in the exterior surface of the molded package section 109B through the molding system 100, including any infinite variety of convex, concave, flat, undulating, faceted, stepped, ribbed, contoured, multi-tiered, textured, asymmetrical, spiraled, polygonal, and freeform organic shapes, with shapes that may be complex in both longitudinal sections and transverse sections of the molded package section 109B with no limitations insofar as the shapes are releasable from the first and second pressing members 102A and 102B. Examples of geometries into which the molded package section 109B, which contributes to the overall shape of the product package 200, described below, may be formed are depicted in FIG. 11A through FIG. 11N, wherein: FIG. 11A shows a contoured shape into which the molded package section 109B is formed in an embodiment; FIG. 11B shows a convex shape into which the molded package section 109B is formed in an embodiment; FIG. 11C shows a stepped shape into which the molded package section 109B is formed in an embodiment; FIG. 11D shows a concave shape into which the molded package section 109B is formed in an embodiment; FIG. 11E shows a textured shape into which the molded package section 109B is formed in an embodiment; FIG. 11F shows a flat shape into which the molded package section 109B is formed in an embodiment; FIG. 11G shows an asymmetrical shape into which the molded package section 109B is formed in an embodiment; FIG. 11H shows an undulating shape into which the molded package section 109B is formed in an embodiment; FIG. 11I shows a spiral shape into which the molded package section 109B is formed in an embodiment; FIG. 11J shows a faceted shape into which the molded package section 109B is formed in an embodiment; FIG. 11K shows a polygonal shape into which the molded package section 109B is formed in an embodiment; FIG. 11L shows a multilayered shape into which the molded package section 109B is formed in an embodiment; FIG. 11M shows a freeform shape into which the molded package section 109B is formed in an embodiment; and FIG. 11N shows a ribbed shape into which the molded package section 109B is formed in an embodiment.

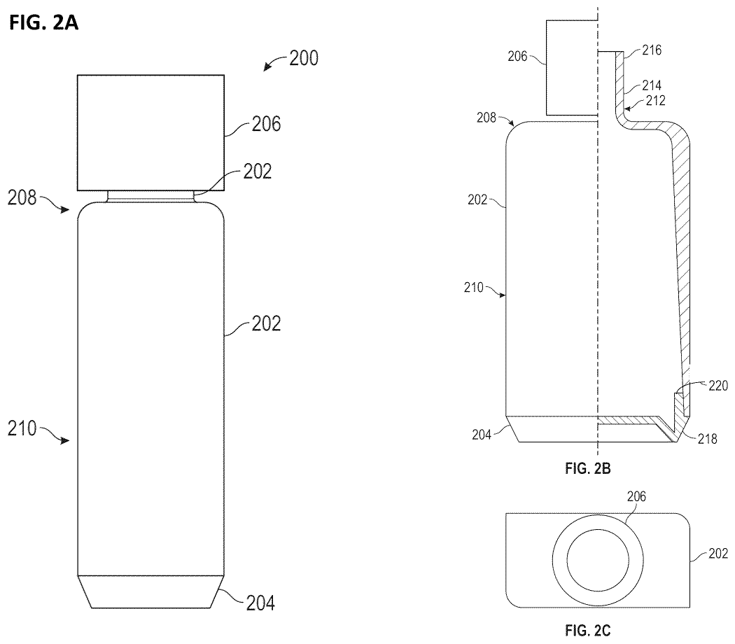

Referring to FIG. 2A, a product package 200 formed with the molding system 100 and method described above in connection with FIGS. 1A-1C is shown in accordance with embodiments of the present disclosure. In embodiments, the product package 200 includes a body (body portion) 202, a neck portion 212 that is integrally connected to the body 202, a base 204, and a closure element 206. The body 202 and the neck portion 212, having been molded as described above in reference to FIG. 1, are each made, at least partially, from pulp fiber.

The product package 200 may be configured in virtually any type of shape, e.g., cylindrical, square, triangular, complex, etc. In embodiments, the body 202 and the base 204 are manufactured separately and joined in a later step, i.e. after the molding of the body 202. The base 204 may be formed from any material of suitable mechanical properties and chemical stability to serve as the base for the product package 200, and in embodiments may be formed in whole or in part from a pulp fiber material.

The body 202 includes a top portion 208 and a bottom portion 210 thereof, and is integrally connected to a neck portion 212. The neck portion 212 defines an opening that fluidly connects to an interior volume of the product package 200. The opening defined by the neck portion 212 is configured to be closed by the closure element 206. In embodiments the neck portion 212 includes an exterior facing screw thread 214 configured to mate with a corresponding interior facing screw thread of the closure element 206. In other embodiments the neck portion 212 includes instead an exterior facing lug portion (not illustrated) configured to mate with a corresponding interior facing lug portion of the closure element 206. In yet other embodiments the neck portion 212 includes instead an exterior facing snap closure portion (not illustrated) configured to mate with a corresponding interior facing snap closure portion of the closure element 206. The exterior facing screw thread 214, exterior facing lug portion, or exterior facing snap closure portion may be provided in the neck portion 212 through insertion molding, through placing a ring insert 115 into the first or second pressing member 102A or 102B in the vicinity of the closed end 112 thereof prior to pressing, as depicted in FIG. 1E, where this insert is of generally a ring shape configured to encircle neck portion 212 of the molded package section 109A or 109B that is to be molded, and comprising the exterior facing screw thread 214, exterior facing lug portion, or exterior facing snap closure portion referenced above, configured to mate with an interior facing screw thread, lug portion, or snap closure portion of the closure element 206. In the embodiment illustrated in FIG. 1E, which shows the first pressing member 102A and the second pressing member 102B when in their separated state, the ring insert 115, which includes the exterior facing screw thread 214, is carried by the second pressing member 102B. It is from this state that, in embodiments, the first and second pressing members 102A and 102B are brought together to form the cavity 106, with the ring insert 115 held between the first pressing member 102A and the second pressing member 102B, and the mold material 50 is molded, as described above, to thereby carry out insertion molding of ring insert 115 in the molded package section (not illustrated) to provide the neck portion 212 of the molded package section with exterior facing screw thread 214 made from a material that is more rigid or stronger than mold material 50. The ring insert 115 may be made of a polymer material, metal material, or other material that is more rigid and/or stronger than the pressed mold material 50.

During the molding process, the body 202 is formed with an opening at the bottom portion 210 into which the base 204 may be fitted and sealed through known connection mechanisms, e.g. adhesive, bonding, press-fitting, etc. That is, the base (base portion) 204 is attached to the body (the molded package section) 202 at an end of the body 202 in the direction 52 in which the core member 104 was withdrawn. In embodiments this bonding may be achieved through the application of a solvent such as water or other liquid solvent to the bottom portion 210 of the body 202 and/or to the base 204 and then bringing these parts into contact with each other, or through bringing these parts into contact with each other before complete drying after molding. In embodiments, the opening in the bottom portion 210 of the body 202 may be used to fill the product package 200 with a product prior to attaching of the base 204 to the body 202. Filling the product package 200 through the opening at the bottom portion 210 has significant advantages over filling through the opening defined in the neck portion 212 as is typically done in polymer molded product packages because they are typically single-piece constructions where the only opening for filling is provided in the neck portion. These advantages include: increased filling speed and efficiency, given that the larger opening at the bottom portion 210 allows for faster product dispensing, reducing fill time and improving production throughput; minimized spillage and improved accuracy, given that the wider opening facilitates precise filling, reducing the risk of spillage or overflow, particularly for viscous or powdered products; enhanced compatibility with automated filling systems, given that many high-speed production lines operate more efficiently when filling through a larger, more accessible; reduced need for specialized filling nozzles, given that narrow-neck filling often requires specialized long nozzles or pressure-assisted filling systems, whereas bottom-filling can use simpler, gravity-fed or bulk-filling methods; improved sealing and integrity of the neck portion, given that the neck portion remains may remain sealed until the final assembly, thus enabling reduced exposure to contaminants, moisture, or oxidation during the filling process; ability to fill with pre-filled inserts or multiphase products, given that the bottom opening allows for insertion of pre-packaged inner liners, secondary compartments, or multiple product layers before final closure; greater structural integrity during handling, given that the sealed neck portion is not stressed during filling, producing a lower risk of deformation or failure, improving package durability; and more sustainable and recyclable design options, given that this method enables alternative sealing techniques (e.g., press fitting, biodegradable adhesives, chemical or mechanical bonding), reducing the reliance on complex, non-recyclable sealing methods used in traditional neck-filling designs.

The product package 200 is shown in FIG. 2B with half of the product package 200 shown in a front view (left side) with the closure element 206 secured to the neck portion 212, with the other half of the product package 200 shown in longitudinal-section view with the closure element 206 removed (right side). In embodiments the wall thickness of the body 202 at the top portion 208 is greater than the wall thickness of the body 202 at the bottom portion 210 as a result of the internal draft angle of the body wall portion 105A of the core member 104 with the walls 108A and 108B of the first and second pressing members 102A and 102B being parallel to the withdrawal direction 51 when molding the body 202.

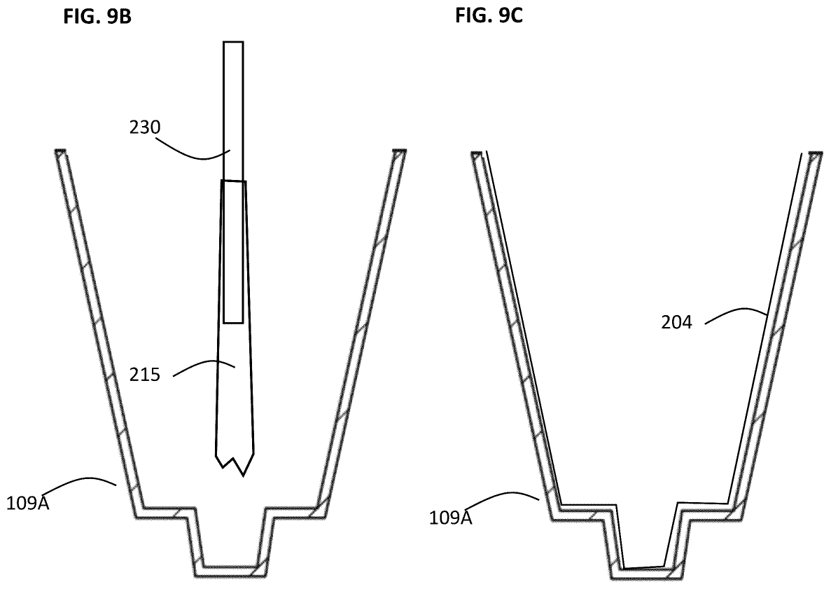

Prior to filling of the product package 200 with a product, some or all of the inner surfaces of the product package 200 may be protected by application of a film 216. The film 216 may be configured and applied to the body 202 after molding the body 202 to isolate the body 202 from the content later filled into the product package 200. In embodiments the film 216 is configured to prevent contact of any contents contained in the interior volume defined by the body 202 from coming into contact with any of the pulp fiber of the body 202. A similar film may be applied to the base 204 prior to the base being secured to the body 202. In embodiments, as depicted in FIG. 9A, the film 216 may be formed by spraying a liquid barrier-forming material 310 from a sprayer 300, comprising one or more jet nozzles, onto the inner surface(s) such that the film 216 forms when the liquid barrier-forming material 310 dries or cures. In other embodiments the film 216 is formed through dipping in a liquid material that can form a suitable barrier.

In embodiments, the film 216 may be made from an extruded sustainable material capable of being biaxially stretched. Further, as depicted in FIG. 9B, the film 216 may be sufficiently pliable, inflatable and/or flexible such that it may be inserted as an expandable membrane structure 215 into the product package 200, or the molded package section 109A thereof, and then inflated to form the film 216 so as to cover the entire inner surface of product package 200 or the molded package section 109A, as depicted in FIG. 9C. That is, the film 216 may be configured to form a seal over the entirety of inner surface of the product package 200. In embodiments the film 216 may be formed through inserting a preform, or an expandable or stretchable membrane structure 215, defining a sealed enclosure with a single inflation port into the interior volume of the body (molded product section) 202 through an opening defined at the neck portion 212 or through the opening of the bottom portion 210 of the body 202 and inflating the preform or expandable membrane structure 215 through application of a pressurized fluid, such as air. In embodiments, this may be achieved through introducing the pressurized fluid via an inflator nozzle 230 or injection system inserted into the inflation port of the expandable membrane structure 215, as shown in FIG. 9B, where the controlled pressure expansion causes the preform or membrane structure to conform to the interior surface of at least a portion of at least the body 202. The expansion may be regulated by pressure sensors, flow controllers, or mechanical constraints to ensure uniform adhesion to the inner walls. In embodiments this inflation may be achieved through filling the expandable membrane, which serves as the film 216, with the actual product that is being packaged.

Application of the film 216 as a solid material, as opposed to as a liquid, may be preferred under some circumstances because the film applied as a liquid may be significantly more difficult to separate from the product package 200. In embodiments, the film 216 may be removably lined along the interior surface, where ‘removably’ is defined as the film 216 exhibiting a cohesion strength significantly greater than its adhesion to the interior surface of the product package 200, thereby allowing the film 216 to be detached and removed easily. Removal of the film 216 from the product package 200 may be performed in a variety of manners (e.g. mechanically, and/or with use of a solvent) to permit recycling or biodegradation of the pulp fiber body 202 and later disposal or recycling of the film 216.

In embodiments the film 216 comprises a biodegradable material, such as, for example: a biodegradable polymer with gas barrier properties such as a polylactic acid (PLA) with a barrier coating (where blending with a nano-clay or silicon oxide (SiOx) coating may improve its gas barrier performance), a polyhydroxyalkanoate (PHA, PHB) (used in multi-layer coatings with starch-based or protein-based barriers), or a polybutylene succinate (PBS) (combined with cellulose nanofibers or a bio-wax); a natural biodegradable barrier coating such as chitosan from shellfish or fungi (blended with stearic acid or beeswax for moisture protection; a starch-based film (combined with PLA, a protein, or a wax), or cellulose nanocrystals/nanofibers (CNC, CNF) (combined with biopolyesters (PBS, PLA) or applied as a laminated biopolymer barrier layer); or a hybrid biodegradable gas barrier such as silicon oxide (SiOx) or aluminum oxide (AlOx) on a biopolymer, or a bio-wax and resin-based coatings such as Carnauba wax, beeswax, shellac, or a rosin, with no limitation to any of the above. Conversely, in embodiments the film 216 comprises a recyclable material such as, for example: a recyclable polyethylene (PE) film such as of high-density polyethylene (HDPE) or low-density polyethylene (LDPE), which may be coated with recyclable ethylene vinyl alcohol (EVOH) for added gas barrier properties or with SiOx (silicon oxide) coatings for better barrier performance; an oriented polypropylene (OPP) or cast polypropylene (CPP) film, which may be metallized (MetOPP) for excellent moisture barrier while maintaining recyclability or given a nano-coating (SiOx or AlOx) to improve gas barrier performance; a recyclable EVOH (ethylene vinyl alcohol) coated film, which may be used in PE/EVOH/PE or PP/EVOH/PP structures for moisture and oxygen resistance or given an SiOx or AlOx coating to improve recyclability while maintaining transparency; or a mono-material barrier film such as, for example, BOPE (biaxially oriented polyethylene), MDO-PE (machine-direction oriented polyethylene), or a PP-based high barrier film, with no limitation to any of the above. In embodiments the film 216 comprises a multilayer film such as, for example: a polyethylene (PE)-based film such as PE/EVOH/PE, MDO-PE/PE, or BOPE/BOPE; a polypropylene (PP)-based film such as PP/EVOH/PP, BOPP/CPP, or MetOPP/PE; a polyethylene terephthalate (PET)-based film such as PET/AlOx/PET, PET/EVOH/PET, or MetPET/PE; a polyamide (nylon)-based film such as PA/EVOH/PE or PA/Tie/PE; a metallized film such as MetPET/PE, MetOPP/PP, or MetBOPP/CPP; a silicon oxide (SiOx) or aluminum oxide (AlOx) coated film such as SiOx-PET/PE or AlOx-OPP/PP; a fully recyclable film such as MDO-PE/PE, BOPE/BOPE, or PE/EVOH/PE; or a bio-based or compostable film such as PLA/PBAT/EVOH or paper/PLA, with no limitation to any of the above.

In embodiments the base 204 includes a ring structure 218 or similar structure at an outer edge of the base 204 configured to provide stability to the body 202 of the product package 200. The ring structure 218 present on the periphery of the base 204 and may be molded into a V-shape to provide circumferential strength. The base 204 may also include a flange 220 along the circumference. In embodiments the flange 220 is configured to couple the base 204 to the body 202. For example, the flange 220 may be sized and shaped to fit closely within the bottom opening of the body 202 and be retained in the bottom opening via friction fit, bonding, adhesive or other attachment structure.

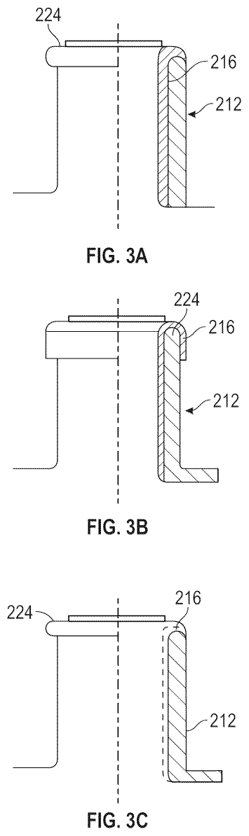

Referring to FIGS. 3A-3C, detailed views of the neck portion 212 of the product package 200 of FIGS. 2A-2C are shown in accordance with embodiments of the present disclosure. In each view, half of the neck portion 212 is shown in a front view (left side) while the other half is shown in a longitudinal-section view (right side). In each longitudinal-section view, an inner surface of the neck portion 212 is shown along with the film 216 applied or adhered to the inner surface of the neck portion 212. FIG. 3A depicts an embodiment wherein the film 216 is blown or extruded to form a seal and barrier layer on the inner surface of the neck portion 212 and on the upper surface of a lip 224 thereof. FIG. 3B depicts an embodiment wherein the film 216 has been applied through stretching so as to extend over the lip 224 of the neck portion 212 to extend to an exterior surface of the neck portion 212. FIG. 3C depicts an embodiment wherein a spray coated or laminated material that serves as the film 216 is coated onto the inner portions of the neck portion 212 and the lip 224.

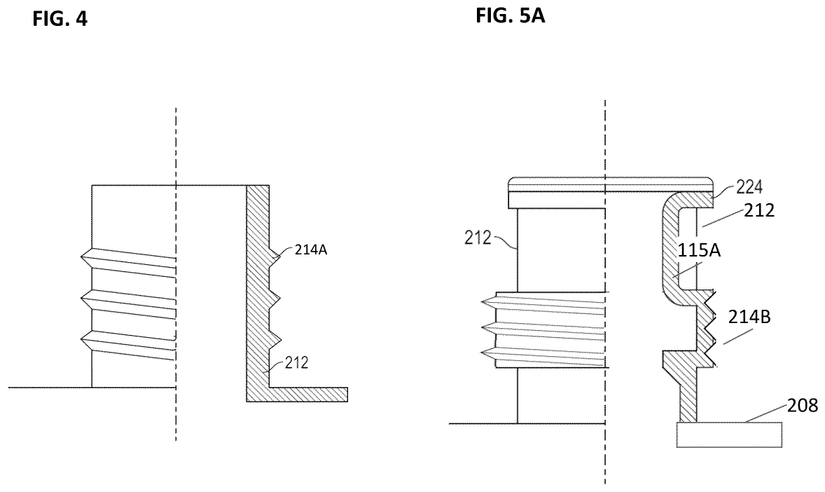

Referring to FIG. 4, a detailed view of the neck portion 212 of the product package 200 of FIGS. 2A-2C is shown in accordance with an embodiment of the present disclosure. In FIG. 4 half of the neck portion 212 is shown in a front view (left side) while the other half is shown in a longitudinal-section view (right side). This view shows an embodiment of the neck portion 212 that includes one option for the screw thread 214 this is formed on or associated with an exterior surface of the neck portion 212. In FIG. 4, a screw thread 214A is formed through molding of the mold material 50 in the neck cavity portion 107 of the cavity 106 formed by the first and second pressing members 102A and 102B. This screw thread can be mated with a threaded closure portion, such as will be described below, to close the product package 200. This provides simple way of providing the screw thread 214 on the exterior of the neck portion 212. The screw thread 214 may be molded in the form of a helix configured to engage with helical threads on an inner surface of the closure element 206 and provide a high degree of positive engagement between the neck portion 212 and the closure element 206 as well as allowing for a user to easily rotate the closure element 206 to engage or disengage the closure element 206 to or from the neck portion 212.

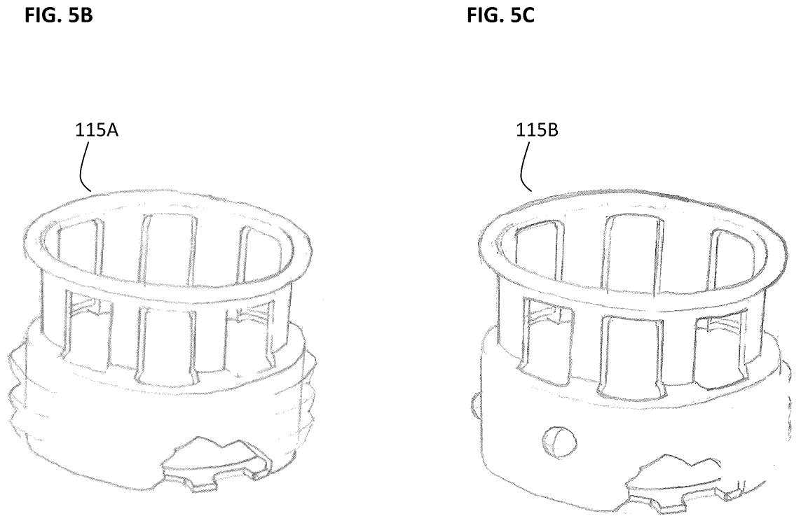

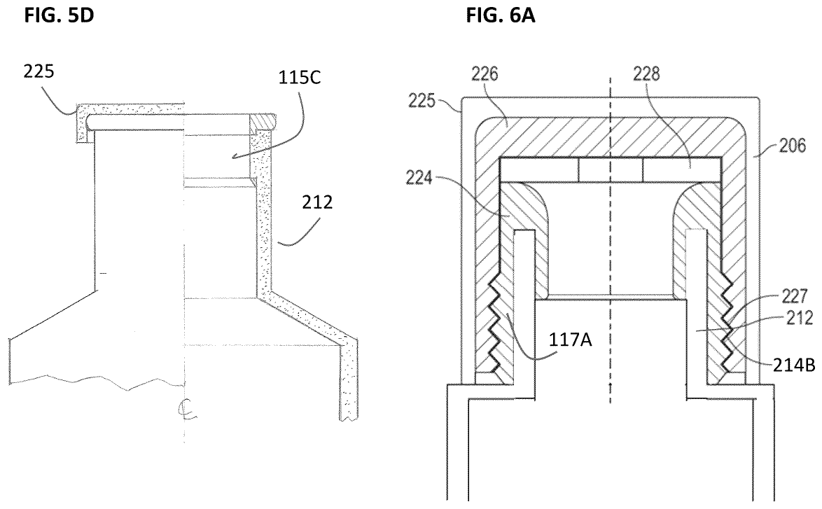

Referring to FIG. 5A, a detailed view of the neck portion 212 of the product package 200 of FIGS. 2A-2C is shown in accordance with an embodiment of the present disclosure. As with FIG. 4, half of the neck portion 212 is shown in a front view (left side) while the other half is shown in a longitudinal-section view (right side). In the depicted embodiment, a screw thread 214B is provided in a threaded ring insert 115A, described previously. The threaded ring insert 115A is incorporated into the neck portion 212 through insertion molding, as described above.

As shown in FIG. 5A, the top of the threaded ring insert 115A may be bent outward to form the lip 224 (or radial flange). One function of the lip 224 may be to provide a sealing surface that an elastomeric seal of the closure element 206 contacts to form a seal of the product package 200 when the closure element 206 closes the opening of the neck portion 212.

FIG. 5B is a perspective diagram showing detail of an embodiment of the threaded ring insert 115A. In embodiments the threaded ring insert 115A may be molded from a polymer or other material that is more rigid and/or stronger than molded pulp fiber. While the threaded ring insert 115A is configured comprising an exterior facing screw thread configured to engage with an interior facing screw thread of the closure element 206, described in greater detail, the ring insert 115, described above, is not limited to being a threaded ring insert 115A, but rather may employ instead a lug ring insert 115B as depicted in FIG. 5C, or a snap portion ring insert 115C as depicted in FIG. 5D.

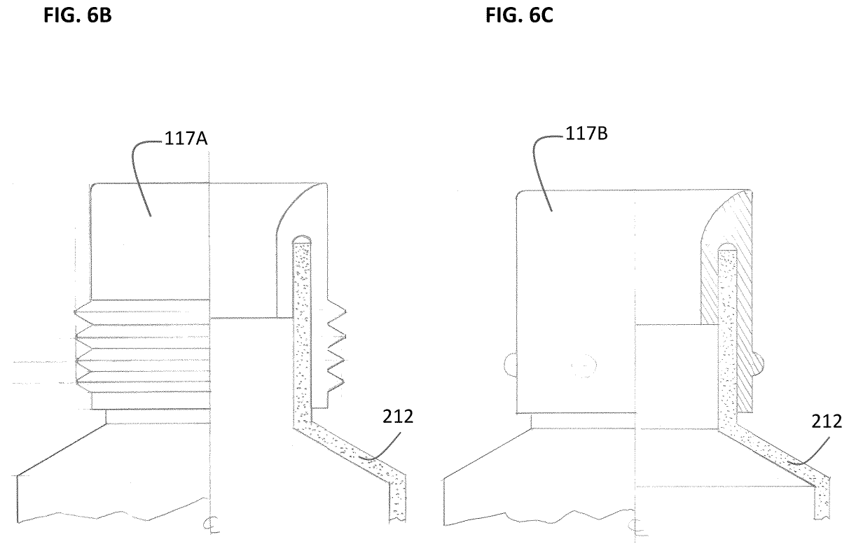

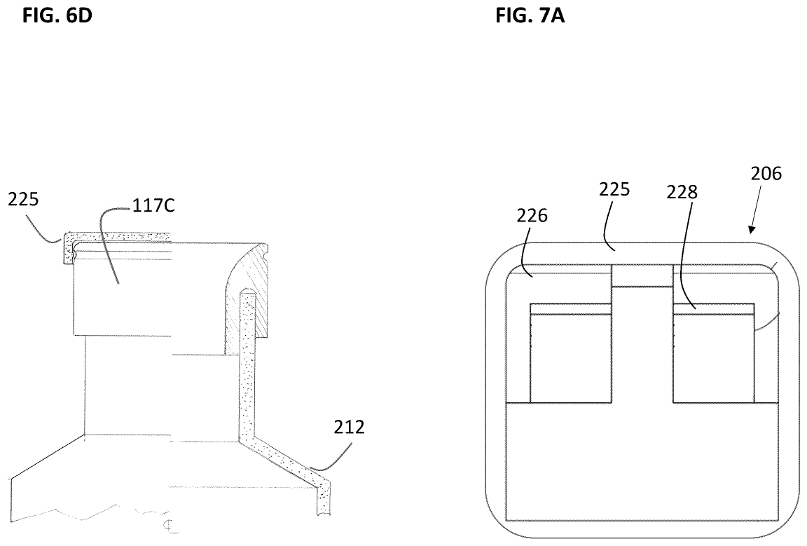

Another embodiment of a neck portion 212 of the product package 200 of FIGS. 2A-2C in accordance with an embodiment of the present disclosure is depicted in FIG. 6A. In the depicted embodiment, the neck portion 212 is equipped with a collar portion 117, in the form of a threaded collar 117A. In this embodiment the screw thread 214 is provided in the form of a screw thread 214B on the threaded collar 117A. The threaded collar 117A is joined to the neck portion 212 after molding of the body 202 and neck portion 212. The threaded collar 117A may comprise polymer, metal, and/or any other material suitable for forming the screw thread 214B for connection with a closure element 206 that is configured to seal the opening of the neck portion from outside of the molded product package 200. In embodiments, the threaded collar 117A is secured to the neck portion 212 through insertion of the neck portion into the threaded collar 117A and being secured therein. The securing of the threaded collar 117A on the neck portion 212 may be through, for example, friction fitting, adhesive bonding, mechanical interlocking, heat staking, ultrasonic welding, or the like. As depicted in FIG. 6A, and described in greater detail below, a closure element 206, comprising a pulp fiber outer portion 225 and an inner portion insert 226, having an interior facing thread portion 227, may be attached to the exterior of the threaded collar 117A by engaging with the screw thread 214B. A sealing element 228, made from, for example, an elastomeric material, may be compressed between the inner portion insert 226 of the closure element 206 and the lip 224 that is provided by the threaded collar 117A.

FIG. 6B is a half section view showing details of the threaded collar 117A according to an embodiment. The collar portion 117 for connecting the neck portion 212 to the closure element 206 is not limited to the threaded collar 117A, but rather may be in the form or a lug collar portion 117B comprising an exterior facing lug portion, depicted in FIG. 6C, or a snap closure collar portion 117C, depicted in FIG. 6D. In embodiments the lug collar portion 117B or snap closure collar portion 117C may be secured to the neck portion 212 in the same manner as described above in relation to the screw thread collar portion 117A.

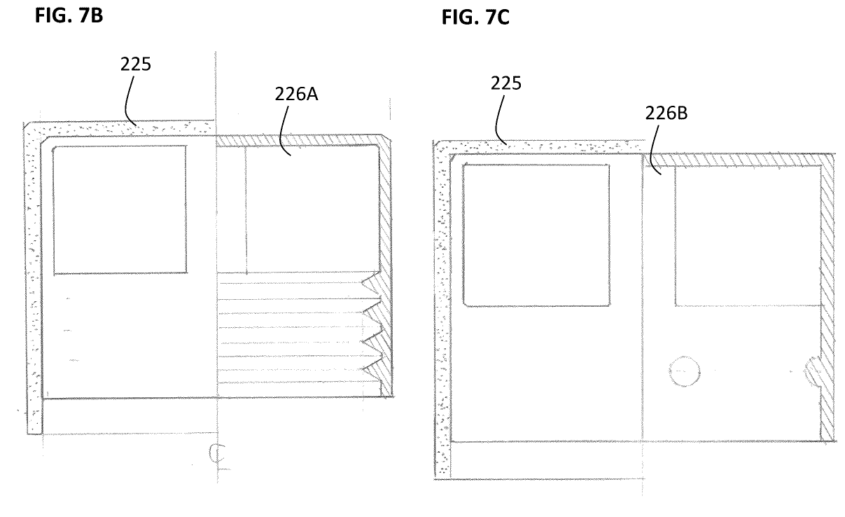

FIG. 7A depicts a longitudinal sectional diagram of an exemplary embodiment of a closure element 206 to be secured to a neck portion 212 according to the present disclosure. In embodiments the closure element 206 includes an outer portion (overcap) 225 that is made primarily from pulp fiber, and a closure insert (inner cap) 226 that is made from more rigid or stronger material, such as a polymer or metal. The closure insert 226 is configured to retain a sealing element 228 (e.g. an elastomer sealing element). In operation, when the closure element 206 is secured to the neck portion 212, the sealing element 228 seats on the neck portion 212 to form a seal and thereby sealing the contents held within the product package from the exterior environment. The seal formed by the sealing element 228 and the neck portion 212 may be a gas-tight and/or liquid-tight seal. Note that the top surface of the outer portion 225 of the closure element 206, in embodiments, is provided with a finger pad (not shown) that is contoured to comfortably receive a fingertip of the use. In embodiments the sides of the outer portion 225 of the closure element 206 may include texturing, knurling, ridges, or other grip-enhancing features to facilitate secure handling and ease of removal by the user.

In embodiments, the closure element 206 secures to the neck portion 212 with an interior facing thread element 227 that is configured to mate or secure with a corresponding exterior facing screw thread element 214 of the neck portion 212, described above. In embodiments the interior facing thread element 227 may be provided in the closure insert 226 as a threaded closure insert 226A that is inserted in the pulp fiber outer portion 225. The threaded closure insert 226A is shown in detail in the half section view thereof that is FIG. 7B. In other embodiments the closure insert is provided as a lug closure insert 226B, which provides an interior facing lug portion (not shown), configured to engage with an exterior facing lug portion 115B or 117B, described above, arranged at the neck portion 212. The lug closure insert 226B, depicted in FIG. 7C, may be provided as a polymer insert that is inserted in the pulp fiber outer portion 225. In other embodiments the closure insert is provided as a snap portion closure insert 226C that provides an interior facing snap closure portion (not shown), configured to engage with an exterior facing snap closure portion 115C or 117C arranged at the neck portion 212, described above.

Given the descriptions above, in embodiments, portions of the neck portion 212 or closure element 206 may be molded from materials other than pulp fiber, e.g., a polymer material or other moldable material. In particular, as described above, a thread, lug, snap-on or similar component of the neck portion 212 or closure element 206 may be partly or wholly formed from a polymer material, and may be provided as an insert, provided by the first or second pressing member 102A or 102B, or by the core member 104, during the pressing and molding process, described above. Specifically, as described above, in embodiments the neck portion 212 may be provided with: a threaded ring insert 115A that is disposed in the neck portion and configured to provide an exterior facing screw thread configured to engage with an interior facing screw thread of the threaded closure insert 226A of closure element 206; a lug ring insert 115B, disposed in the neck portion 212, configured providing the exterior facing lug portion configured to engage with the interior facing lug portion of the lug closure insert 226B of the closure element 206; or a snap portion ring insert 115C, disposed in the neck portion 212, configured providing an exterior facing snap closure portion configured to engage with an interior facing snap closure portion of the snap portion closure insert 226C of the closure element 206.

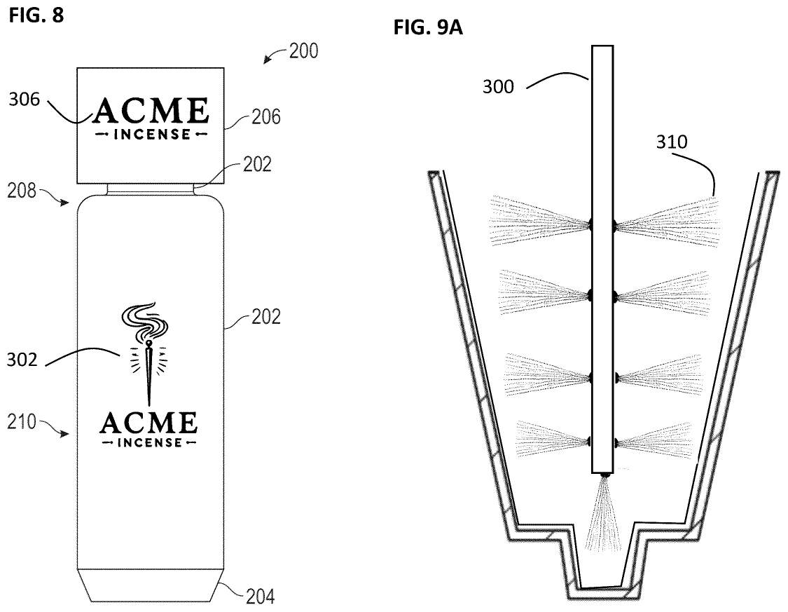

The product package 200 and the outer portion 225 (overcap) of the closure element 206 may each be configured as desired to have any type of finish, surface treatment, branding/graphical indicia, labels, and the like, and may include a printed portion. In embodiments the body 202, neck portion 212, base 204, and/or outer portion of the closure element 206 is used a surface to bear labeling, such as depicted in FIG. 8, which illustrates labeling 302 for product branding information on the body 202 and labeling 306 for product branding information on the closure element 206. In embodiments the labeling may comprise, for example, product branding information, a logo, nutritional information, a UPC, a QR code, content information, volume or weight labeling, regulatory compliance information, recycling instructions, expiration date markings, lot or batch numbers, barcodes, handling or storage instructions, allergen warnings, multilingual translations, promotional or marketing messages, authentication or anti-counterfeiting markers, hazard warnings, and/or tamper-evident indicators. In embodiments embossing, debossing, direct printing, pad printing, screen printing, digital printing, laser etching, thermal transfer printing, hot stamping, cold stamping, in-mold labeling (IML), pressure-sensitive adhesive labels, shrink sleeves, stretch labels, wrap-around labels, glue-applied labels, inkjet printing, flexographic printing, gravure printing, RFID or NFC tags, tamper-evident seals, or any combination thereof.

The pulp fiber material may be sustainably harvested or made directly from harvested pulp material or from waste or recycled material. Many plant-based, agriculturally-sourced materials are amenable to being reduced by shredding or similar processes to a pulp fiber that may then be molded into various forms, including packaging material. Pulp fiber sources include, but are not limited to, trees, bamboo, bagasse, wheat straw, hay, sugar cane, corn stalks and banana leaves. In addition, many recycling streams are capable of providing the same of very similar pulp fiber material. Thus, recycled materials such as newsprint, waste paper, discarded paper pulp and sawdust may be used as an input to a pulp fiber input stream. More generally, the mold material 50 used in embodiments may derive from: plant-based fibers and biomass materials such as bagasse (sugarcane fiber), hemp fiber, flax fiber, coconut coir, bamboo fiber, kenaf fiber, wheat straw fiber, corn husk fiber, and cotton linter; biodegradable polymers and bioplastics such as polylactic acid (PLA), polyhydroxyalkanoates (PHA, PHB), polybutylene succinate (PBS), thermoplastic starch (TPS), chitosan, and gelatin-based bioplastics; mycelium-based materials such as mushroom mycelium packaging and MycoComposite materials; mineral-infused sustainable materials such as calcium carbonate biocomposites, clay-based composites, and silica-based eco-composites; recyclable and reprocessed natural materials such as recycled paperboard, recycled cardboard pulp, recycled cotton and textile fibers, and recycled newspaper pulp; algae and seaweed-based materials such as agar-based biopolymers, alginate packaging films, and seaweed-based composite materials; or hybrid sustainable composites such as pulp fiber with PLA or PHA coatings, hemp with a bioplastic matrix, bagasse blended with recycled fiber, and mycelium combined with agricultural waste, where these materials may be prepared through shredding, flaking, drying, pulping, grinding, milling, or other fiber-processing techniques to achieve a moldable consistency, and may be mixed with water, binders, or additives to enhance mechanical properties, barrier performance, and moldability. The term “pulp fiber” in the present embodiments is to be understood as a general term including all of these materials.

Various appropriate additives may be added to a pulp fiber slurry before molding as described above. In non-limiting embodiments these additives may include: strengthening agents to increase the mechanical strength and durability of the molded fiber product, such as starch to improve binding strength and rigidity, carboxymethyl cellulose (CMC) to enhance fiber bonding and water retention, polyvinyl alcohol (PVA) to provide improved adhesion and tensile strength, latex or rubber emulsions to add flexibility and water resistance, and nanocellulose (CNF or CNC) to increase strength and barrier properties while remaining biodegradable; barrier and water-resistant additives to reduce water absorption and improve moisture resistance, such as waxes (paraffin, carnauba, beeswax) to provide hydrophobicity, silicone-based compounds to improve water repellency, aluminum sulfate (alum) to improve water resistance and control pH, and fluorine-free hydrophobic coatings that are used for food-grade packaging; fire retardants for flame-resistant applications, such as boron compounds (borax, boric acid) to act as a fire retardant and prevent mold growth; ammonium phosphate to provides fire resistance, and aluminum hydroxide to release water when heated, thereby reducing flammability; oil and grease resistance (OGR) agents that are used for food packaging or industrial applications, such as kaolin or bentonite clay to create a natural grease barrier, alkyl ketene dimer (AKD) to increase oil and grease resistance, and polyvinylidene chloride (PVDC) or polyvinyl alcohol (PVOH) coatings to improve resistance to grease and oxygen; biodegradable or compostable additives to maintain eco-friendliness while enhancing performance, such as polylactic acid (PLA) fibers to improve moisture resistance and compostability, polyhydroxyalkanoates (PHA) to enhance biodegradability, and lignin-based binders as natural plant-derived binder to improve strength; colorants and optical brighteners for color customization and whitening effects, such as titanium dioxide (TiO₂) to provide whitening and opacity, iron oxides or natural dyes to provide earth-tone colors, and organic pigments for custom coloring of molded fiber; and pH modifiers and process aids that are used to control pH and improve processing efficiency, such as calcium carbonate (CaCO₃) to adjust pH and improve opacity, sodium hydroxide (NaOH) to help with fiber breakdown, and enzymes (e.g., cellulases, hemicellulases) to improve fiber bonding and reduce refining energy, where these additives may be used singly or in combinations thereof.

Although molded pulp or molded fiber in the packaging material industry have been used for a variety of applications, such as food service trays, egg container, bowls, and the like, no one in industry has been able to produce a molded pulp fiber product package with a neck portion that is configured to be closed with a closure element as provided in the present disclosure.

The product packages of the present disclosure may be sized and shape for a variety of applications and industries. For example and without limitation, a product package according to the present disclosure may be configured to retain product materials in the range of 5 mL to 750 mL.

Although features of the present disclosure have been described in connection with different embodiments for simplicity, one of ordinary skill in the art should readily understand that various features may be applicable to and readily incorporated into other embodiments.

As will be recognized by those of skill in the pertinent art, numerous changes and modifications may be made to the above-described embodiments of the present disclosure without departing from the spirit of the invention. Accordingly, the particular embodiments disclosed in the specification are to be taken as merely illustrative and not limiting.

The components, elements, modules, and processes described throughout this specification are intended to be illustrative and not restrictive. Unless explicitly stated otherwise, each of these elements may be implemented in hardware, software, or firmware, alone or in any combination thereof. The specific structure of the elements may vary based on implementation requirements or technological advancements.

It is understood that the embodiments and examples described herein are not intended to limit the invention, and the various components and functions can be recombined, modified, substituted or omitted without departing from the scope of the invention. The elements in different embodiments may be arranged or integrated in different ways, and may operate independently or in conjunction with one another to perform the desired functionality.

What is claimed is:

1. A method of forming a molded product package comprising:
providing a molding system, the molding system comprising:
a first pressing member;
a second pressing member; and
a core member;
introducing mold material into a space formed between the first pressing member and the second pressing member;
inserting the core member into a cavity defined by the first pressing member and the second pressing member so as to press the mold material between the core member, the first pressing member, and the second pressing member; and
withdrawing the core member from the mold material and moving the first pressing member and second pressing member away from each other to form a molded package section from the mold material.

2. The method according to claim 1, wherein the core member is configured with a draft that is angled to facilitate withdrawal of the core member.

3. The method according to claim 1, wherein the mold material comprises pulp fiber.

4. The method according to claim 1, further comprising applying a film to an interior surface of the molded package section and inserting a preform or an expandable membrane structure defining a sealed enclosure with a single inflation port into an interior volume of the molded product section through an opening defined at a neck portion of the molded package section or through an opening defined at a bottom of the molded package section and inflating the preform or expandable membrane structure through filling the expandable membrane structure with a product.

5. The method according to claim 1, further comprising attaching a base portion to the molded package section at an end of the molded package section in the direction in which the core member was withdrawn.

6. The method according to claim 1, wherein the first pressing member and the second pressing member fit together to form a substantially closed mold, leaving only an opening for insertion of the core member, wherein a parting line between the first pressing member and the second pressing member extends parallel to the direction in which the core member is inserted and withdrawn.

7. The method according to claim 1, wherein an insert, structured from a rigid material and configured to mate with a closure portion, is provided to a neck portion of the molded package section by the first pressing member, the second pressing member, or the core member.

8. The method according to claim 1, wherein a collar, structured from a rigid material and configured to mate with a closure portion, is provided on a neck portion of the molded package section.

9. A method for manufacturing a packaged product, comprising:
the method according to claim 5; and
filling the molded package section with a product from the end of the molded package section in the direction in which the core member was withdrawn, where said filling with the product is performed prior to the attaching the base portion.

10. A molded product package comprising:
a body portion;
a base portion connected to an end of the body portion opposite from an end of the body portion to which the neck portion is connected; and
a neck portion integrally connected to the body portion and defining an opening fluidly connected to an interior volume defined by the body portion and the base portion;
wherein at least one of the body portion, the neck portion, and the base portion comprises pulp fiber.

11. The molded product package according to claim 10, further comprising a closure element configured to seal the opening of the neck portion from an exterior of the molded product package, wherein the closure element comprises pulp fiber.

12. The molded product package according to claim 10, further comprising a closure element configured to seal the opening of the neck portion from an exterior of the molded product package, wherein the closure element comprises a closure element insert and an overcap, wherein the overcap is made primarily of pulp fiber.

13. The molded product package according to claim 12 wherein:
the closure element insert defines an interior facing screw thread configured to engage with an exterior facing screw thread arranged at the neck portion;
the molded product further comprising a threaded ring insert, disposed on the neck portion, configured providing the exterior facing screw thread configured to engage with the interior facing screw thread of the closure element.

14. The molded product package according to claim 12, wherein:
the closure element insert defines an interior facing lug portion configured to engage with an exterior facing lug portion arranged at the neck portion;
the molded product further comprising a lug ring insert, disposed on the neck portion, configured providing the exterior facing lug portion configured to engage with the interior facing lug portion of the closure element.

15. The molded product package according to claim 12, wherein the closure element insert defines an interior facing snap closure portion configured to engage with an exterior facing snap closure portion arranged at the neck portion;
the molded product further comprising a snap portion ring insert, disposed on the neck portion, configured providing the exterior facing snap closure portion configured to engage with the interior facing snap closure portion.

16. The molded product package according to claim 10, wherein:
the closure element insert defines an interior facing screw thread configured to engage with an exterior facing screw thread arranged at the neck portion;
the molded product further comprising a threaded collar, disposed on the neck portion, configured providing the exterior facing screw thread configured to engage with the interior facing screw thread of the closure element.

17. The molded product package according to claim 10, further comprising a film lining an interior surface of the body portion and/or the base portion that defines the interior volume, wherein the film comprises cellulose nanofibers.

18. The molded product package according to claim 10, further comprising a film lining an interior surface of the body portion and/or the base portion that defines the interior volume, wherein the film is of a recyclable material.

19. The molded product package according to claim 10, wherein the body portion is asymmetrical with respect to an axial direction of the neck portion.

20. The molded product package according to claim 10, wherein the exterior surface of the body portion is configured in a shape selected from one or more of convex, concave, flat, undulating, faceted, stepped, ribbed, contoured, multi-tiered, textured, asymmetrical, spiraled, polygonal, or freeform organic shapes, wherein the exterior surface of the body portion is configured to be releasable from a first pressing member and a second pressing member upon separation of the first pressing member and the second pressing member.
